(19) United States
(12) Patent Application Publication
(10) Pub. No.: US 2003/0046373 A1
(43) Pub. Date: Mar. 6, 2003

(54) Electronic facilitation venue

(76) Inventor: Donald Sidney Merrill, Chico, CA (US)

Correspondence Address: Donald Sidney Merrill, Apartment 41, 294 Rio Lindo Ave., Chico, CA, 95926-5507, US

(21) Appl. No.: 09/945,176

(22) Filed: Sep. 4, 2001

(51) Int. Cl. H04L 9/32; G06F 11/30; G06F 12/14; G06F 15/177

(52) U.S. Cl. 709/220

(57) ABSTRACT

The Interorganizational IT environments envisaged by Felix Kaufman in his article, 1966 Harvard Business Review became reality with the establishment of the Internet. System's components are distributed through out a network of remote locations having no single defining venue or environment. A dumb service network with very smart end-points where Security is accomplished by specialized hardware and software, but complete security makes the system impossible to use. System costs are determined by the degree of insecurity you are willing to accept.

The Internet boom isn't. A few true believers still cling to the hope of broadband technology, and die-hards actually blame the slow rollout of broadband as the reason for the collapse. The truth is broadband for the Internet has never been economically or technically feasible. What began as a deliberately decentralized network to promote the exchange between disparate computers has became smart terminals tied together by a dumb network that functions automatically.

In this document we deal with a place, Virtual Space formed by construction of an electronic enclosure producing utility as a natural product, and resulting in an Electronic Facilitation Venue. The question of cost disappears or becomes too small to be significant, productivity increases exponentially. As local venues and old ways of facilitation give way to a regional electronic facilitation venue problems of time and space fade. While some individuals will continue to attempt operations in the old way, hoping that broadband will resuscitate the old and familiar. The new will gradually expand to fill the void created by the absence of Space/Time.

### TITLE AND BACKGROUND

A great deal of time and effort has been invested in the development of the Internet's architecture to create an efficient venue for exchange of information; however, this very specific function was never designed to do anything else. These facts are central to understanding the subject of this proposal: Electronic Facilitation Venue (EFV).

The U.S. Department of Defense (DOD) wanted a means to network its many disparate computers in large part, to achieve a reliable exchange of information. Using Packet Switching Technology (PST), Transport Control Protocol (TCP), and the Internet Protocol (IP), they created the first large-scale deployment of the Internet. Security focused on establishing and enforcing limited access as the central means of security for the system. The eventual inclusion of the Academic community brought the concept of free flow of Ideas and a clash of cultures. True security has become no longer possible.

Today, all user problems on the Internet are found in designs centered on solutions that involve using off-the-shelf software and hardware to create a webpage where Information Technology (IT) can operate without the necessity of imposing security features that increase costs and restrict system performance. In order to implement an entity that would conform to the outline above requires a very special type of Venue, and the application of highly sophisticated network technology. It will require a new way of looking at the problem and a brand new perspective on its implementation.

Electronic Facilitation Venue Wide Area Network (EFV WAN)

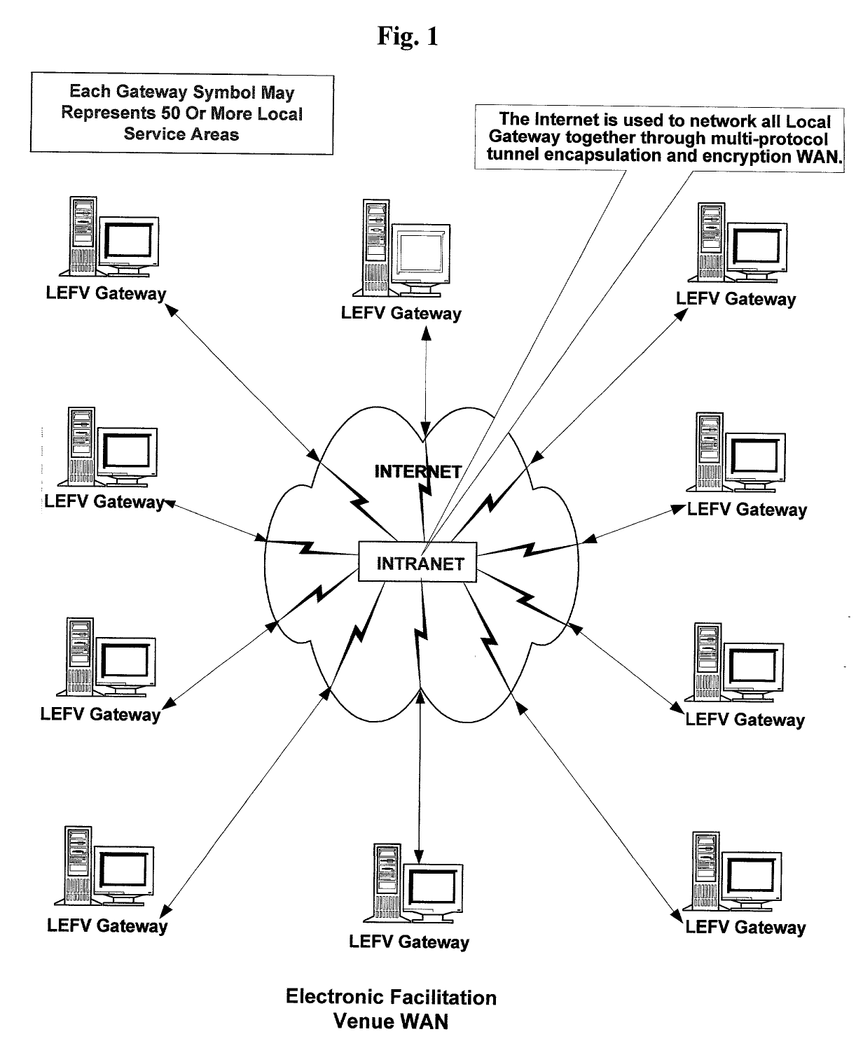

(See: FIG. 1, opposite page for reference)

Each icon in the FIG. 1 represents a Local EFV WAN Gateway. Although the minimum number is just one, if the EFV function requires more than one, each will be connected to any other through a Router attached to the Internet. The designation is generic for this piece of hardware. It is most frequently used to connect two logically and physically different networks; however, in this case it will function as a secure link between identical units. In addition, it must be able to receive and send traffic between separate LEFV, and be programmed to filter and direct traffic based on an Internet address to specific locations within the EFV WAN. Each of the Local EFV Gateways is designed to create encapsulated Internet communication of out-going traffic to form a secure Wide Area Network or WAN. In-coming traffic for each Gateway will be processed and filtered so that only the specific address of its own Gateway is allowed access. In this way the Internet is being used in one of the ways it was originally intended, as a means of networking networks. As a result all traffic on the WAN will be virtually invisible to other Internet traffic. Each EFV Gateway Router will be assigned to a specific Local Gateway. The net result is a cost-effective method of creating a secure virtual venue for any IT function. User system design focus can be directed to the problems of doing the job required by a specific task and making sure all of the component parts for the job work together. Quite simply the LEFV facilitates any IT function it has been assigned to perform.

Local Electronic Facilitation Venue (LEFV) WAN Gateway

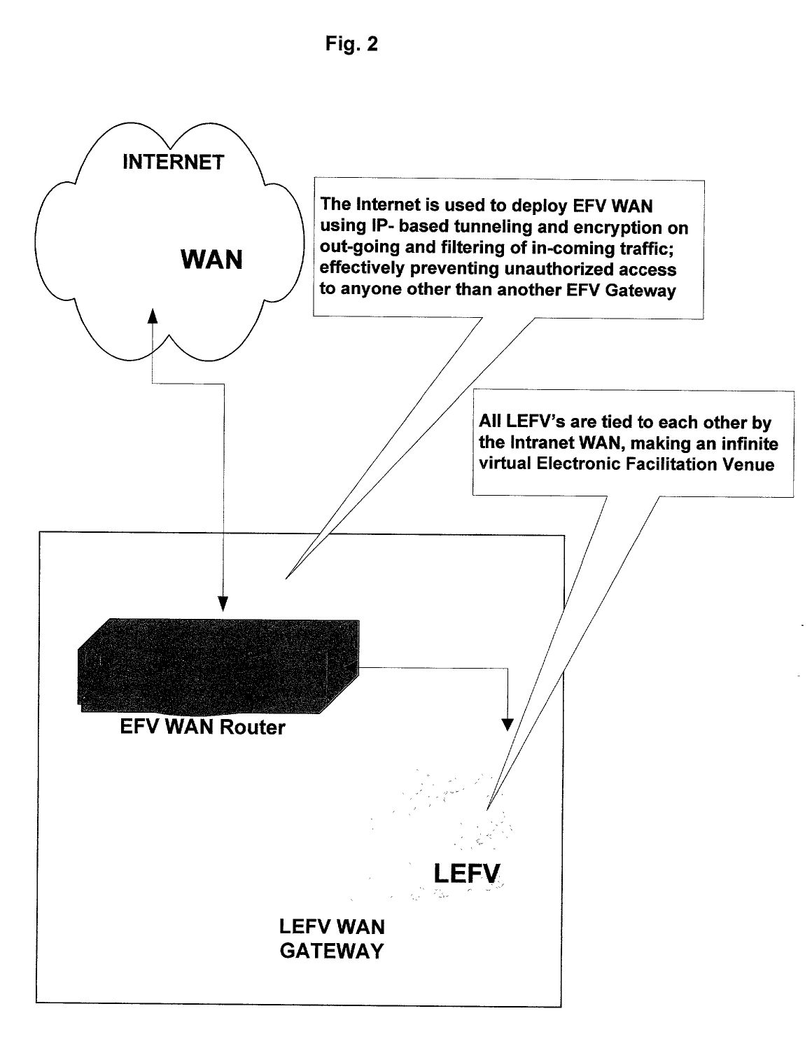

(See opposite page, FIG. 2 for Reference)

The diagram represents the component parts of the local WAN connection to the Internet by the LEFV. It is designed to be the most secure connection for communications on the Internet and at the same time must be transparent to other Internet traffic. Each LEFV Router assigned to a specific LEFV uses advanced encryption and tunneling to permit the organization to establish secure, LEFV WAN.

Gateway filters must limit incoming traffic to the specific address of the LEFV. To do this, requires a unified solution of a more robust Router and layer 3 IP-based tunneling and encryption. In addition, it will require single port deployment to an IP cloud to attain meshed connectivity among each location on the Intranet WAN.

The Cisco 7100 series Router is an example of such a unit. “Cisco 7100 Series Router (Cisco Systems, Inc.) deliver tunneling and encryption services suitable for sit-to-site Intranet, extranet, applications. As scalability requirements increase, an optional Integrated Services Adapter is installed for encryption acceleration and tunnel scalability . . . For perimeter security applications, the 1700 also support IOS Firewall feature sets, enabling packet filtering on the routing infrastructure. This system enables the enterprise to choose WAN transport best suited to their needs.” This example of off-the-shelf equipment available for specific tasks may require some modification but are minor and cost effective.

Internet Services Access

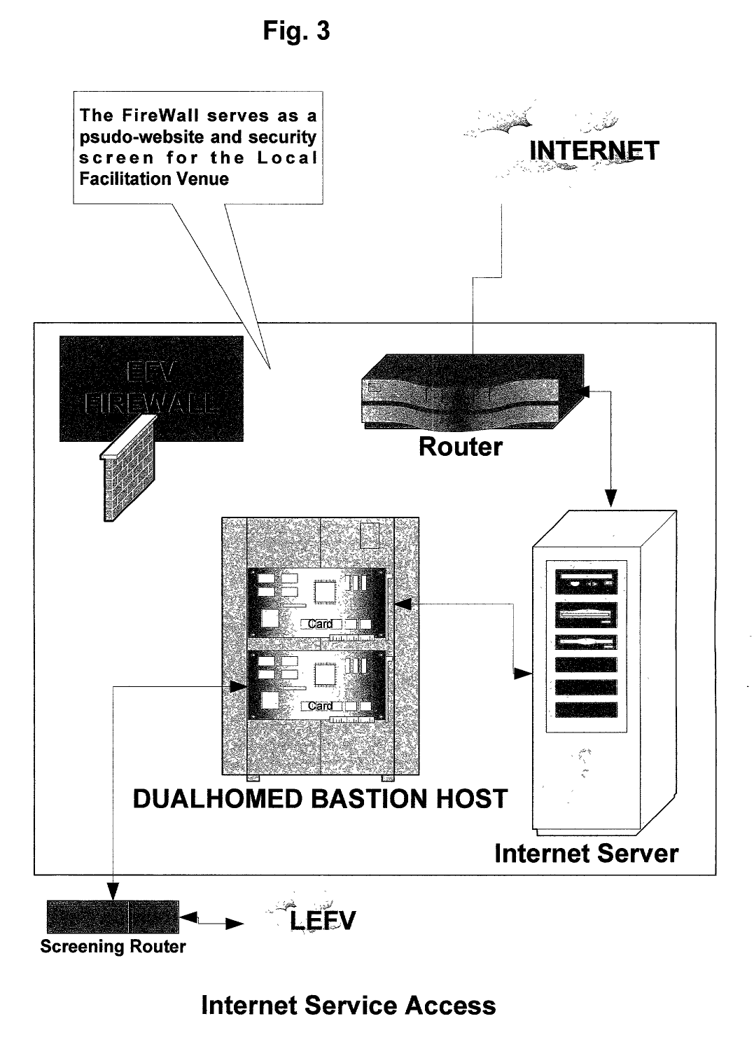

(See opposite Page, FIG. 3 for reference)

Three types of hardware handle the second route of EFV Internet connection; two Routers, Internet Server, and a Dual Homed Bastion Host. The hardware components make implementation possible while application software acts as the process director. The diagram shows a generic Host with two network cards as our first line of real security for open service traffic from the Internet. Many computer systems have the ability to function with more than one network card. Separate cards effectively cut the direct link and isolates incoming traffic from the EFV. An Internet Server acts as a gatekeeper and proxy to analyze all in coming traffic destined for the Bastion Host.

Incoming Internet packets are first checked by a Router using packet filtering and then either dropped or allowed to enter based on various rules and specified criteria. In the second step, proxy services act as agents for the Internet user who needs to communicate with the other side of the firewall. There are two advantages of proxy servers. First, users do not directly control requests for access nor do they log onto or have an account on the Bastion Host. Second, the use of audit trails allows the server to keep track of the type and number of the transactions on the server. The Bastion Host with its dual network cards effectively cuts any direct link to the LEFV and thus becomes a dead end for any direct link with the EFV by an unauthorized Internet user. A screening Router attached to the second network card of the Bastion eliminates any traffic not identified as LEFV Host traffic.

Local Electronic Facilitation Venue

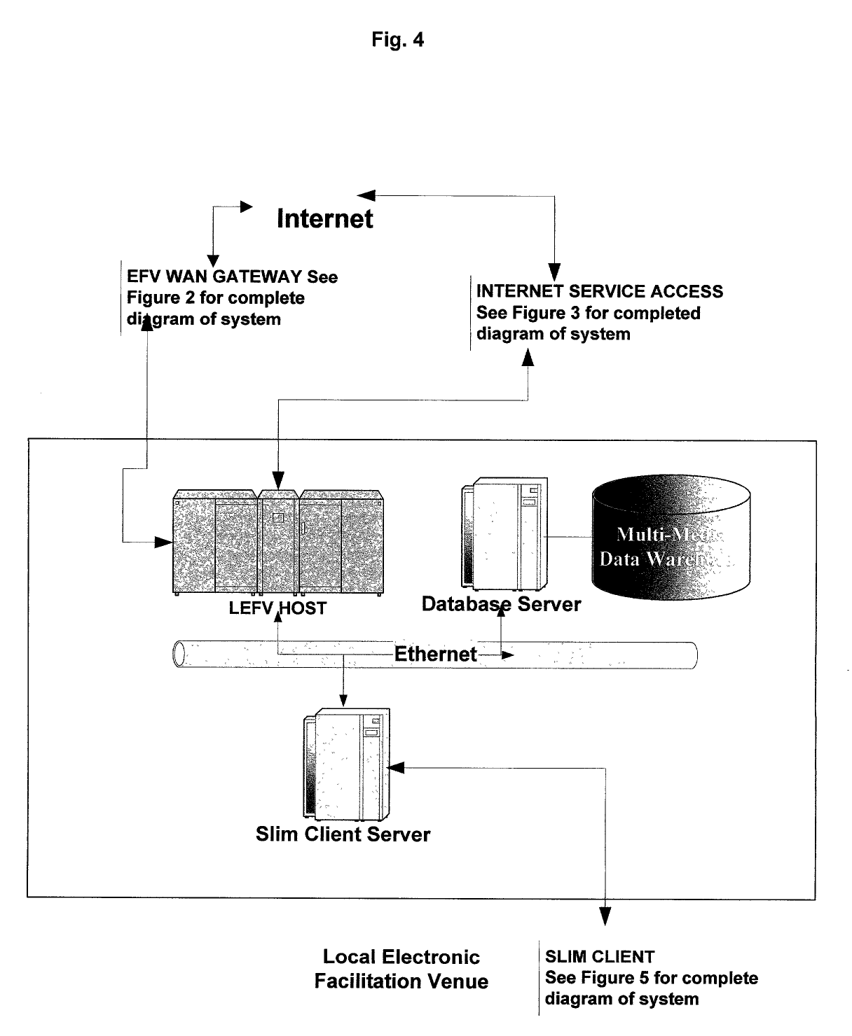

(See opposite page, FIG. 4 for Reference)

We often hear people talk of using the Internet for this or that project. This idea is a consequence of simple misconceptions about the nature of the Internet. As we indicated earlier, the Internet is designed to facilitate exchange of information between disparate computers. This is a “service” rather than a “utility” function. A utility function requires virtual space formed by construction of an electronic enclosure. Although this space is an intellectual construct, the enclosure that forms it must be carefully designed to give maximum freedom to the user inside, but none at all outside.

This diagram represents the real object and purpose of this proposal, a Virtual Electronic Facilitation Venue. It is Virtual because it only exists as an electronic entity; Facilitation because it offers a secure environment for any processes needing its services; Venue because it is a place where any suitable IT function can be performed.

The upper left area of the diagram shows the relationship of the two different connections to the LEFV and its Host System. The Host must handle traffic from both the FireWall and the WAN Gateway; therefore, it must be a very robust system. The lower right of the diagram shows the connection of a thin client devise used for display of application to the user. Because of their simplicity they are immune to the abuses normally associated with the more robust workstation or PC, and can be designed to deliver fast deployment of both application software and hardware with higher reliability, less cost, grater manageability, and security. The end-user of the system need only deal with a simple appliance to access any or all services.

Thin Client System

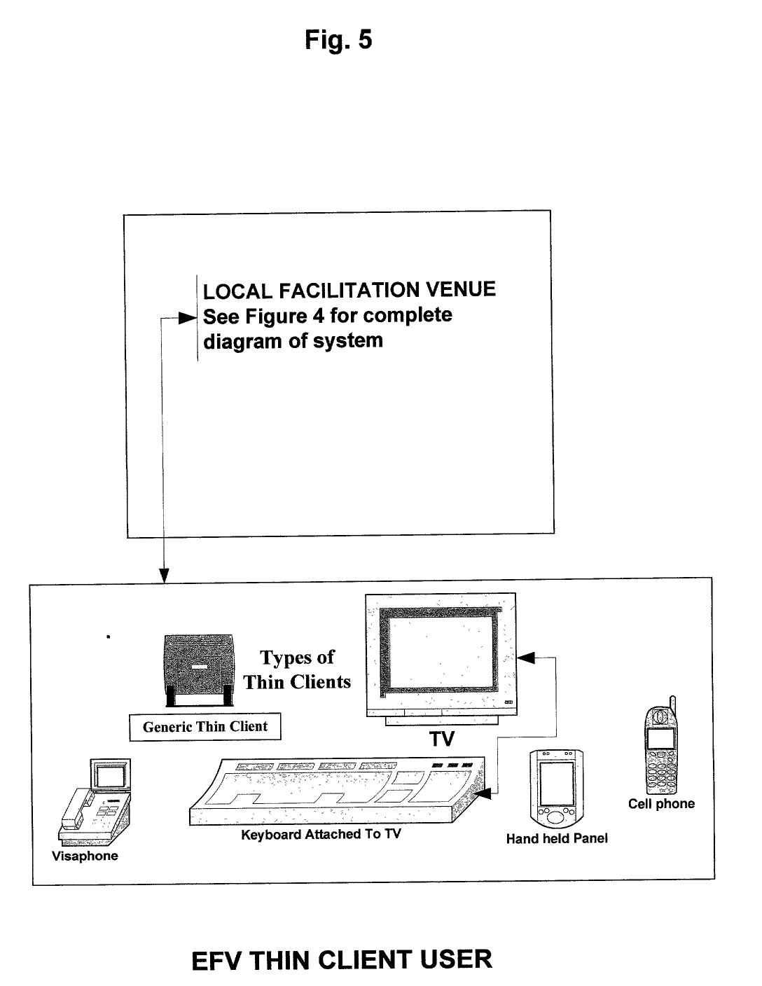

(See opposite Page, FIG. 5 for reference)

Thin client is a generic term used to describe an appliance designed to execute only application software received from hardware on the EFV. The thin client simply brings the application display to you. Because of their relative simplicity, thin clients can be designed to deliver much higher reliability, as well as much easier manageability, with faster deployment of both software and hardware, at far lower cost than you would get with a personal computer. Thin clients can be as large as a “dumb” terminal or as small as a large hand calculator.

Thin client immunity to problems presently seen with Internet use is based in part by the fact it does not have the complexities of PCs or Workstations. A study a year or so ago, determined 70% of viruses were introduced through floppy disks, the others come imbedded in applications designed to attack the hard drive, where the file application tables are erased; thus, the drive no longer knows where the data is stored. By eliminating this hardware, thin clients avoid viruses.

The thin client allows the user to view what is happening on the LEFV, yet eliminates control of the process. Application software needed to perform their function is provided by the LEFV. The unit's Firmware provides the intelligence needed to receive application software from the EFV, but its simplified architecture make the devices substantially smaller, cheaper, and easier to use than the typical workstation or personal computer. The power and control of the “Smart” terminal is no longer needed.

I claim my idea if accepted for patent protection and implemented will show:

1. Virtual Space formed by construction of an electronic enclosure produces utility as a natural product, resulting in an Electronic Facilitation Venue.

2. By its nature infinite in scope because of its capacity to grow by replication into any suitable area, and constructed with an ability to communicate through secure channels within the Internet makes each venue one single global space.

3. It will constitute a single architecture comfortable with a wide variety of IT functions, offering increases in productivity, and eliminate expense no longer needed for support of old-fashion facilitation methods.

4. It will contribute to the evolution of the computer. Its complexity mitigated by merging with each element of the venue, then using the result to drive it; thus, eliminating the need for “smart” equipment for the end-user and using a simple appliance to receive all needed application software from the LEFV.

5. It will represent a new, huge, level, playing field without the impediment of large capital requirements for the entrepreneur.

6. The individual or an organization need only establish a single presence on the electronic venue to facilitate communication or information exchange through out the venue.

7. Finally, it will eliminate the need for multiple equipment imposed by old space/time restrictions on a single type of IT transaction.
